(19) United States
(12) Patent Application Publication
(10) Pub. No.: US 2007/0283297 A1
(43) Pub. Date: Dec. 6, 2007

(54) Signal processing circuit

(76) Inventors: Thomas Hein, Munich (DE); Rex Kho, Holzkrichen (DE)

Correspondence Address: SLATER & MATSIL, L.L.P., 17950 PRESTON ROAD, SUITE 1000, DALLAS, TX, 75252, US

(21) Appl. No.: 11/443,491

(22) Filed: May 30, 2006

(51) Int. Cl. G06F 17/50

(52) U.S. Cl. 716/1

(57) ABSTRACT

A signal processing circuit includes a first circuit including a first clock signal generator with an output for a first clock signal and a second clock signal generator with an output for a second clock signal and an input for a comparison signal. The second clock signal is generated by the second clock signal generator based on the comparison signal. A second circuit includes a phase detector with a first input for the first clock signal, with a second input for the second clock signal and an output for the comparison signal indicating a relation between the phases of the first clock signal received at the first input and the second clock signal received at the second input.

### TECHNICAL FIELD

The present invention relates to a signal processing circuit, especially a circuit comprising a memory controller or a processor and a memory circuit, for instance, a high-speed memory and a graphics processing unit (GPU).

### BACKGROUND

In modern high-speed memory circuits, especially in high-speed DRAM circuits (DRAM=Dynamic Random Access Memory), a memory circuit and a memory control circuit or a processor are connected by a unidirectional address/command bus and by a bi-directional data bus. Usually, each of both busses comprises a separate clock line. Sometimes, the data bus comprises a clock strobe line instead of a separate clock line.

In a DRAM memory circuit, the address/command bus usually controls the actions carried out inside the data path of the DRAM memory circuit. All information concerning the timing with respect to commands and address (command/address-timings) is derived from the clock signal of the address/command bus, which is usually referred to as the CK-clock or command clock.

All data are written to the DRAM memory circuit based on a data clock signal RDSQ, which is usually referred to as Read DQ Strobe. The output of the data from the DRAM memory circuit is aligned to the RDQS.

The relationship between the data clock signal RDSQ and the clock signal or command/address clock signal CK with respect to their arrangement in time is normally specified to be within +/−0.25·tCK of each other, wherein tCK is a period of the clock signal of the CK-clock or command clock. As both clock signals are created at different sites inside a controller circuit, for instance, a graphics processing unit (GPU) and as both clock signals are distributed via different paths or clock signal lines on their way to the DRAM memory circuits, it is difficult to ensure this certain alignment of the data clock signal RDQS and the clock signal CK with respect to each other.

### SUMMARY OF THE INVENTION

According to an embodiment of the present invention, an inventive signal processing circuit comprises a first circuit comprising a first clock signal generator with an output for a first clock signal and a second clock signal generated with an output for a second clock signal and an input for a comparison signal, wherein the second clock signal is generated by the second clock signal generator based on the comparison signal, and a second circuit comprising a phase detector with a first input for the first clock signal, with a second input for the second clock signal and an output for the comparison signal indicating the relation between the phases of the first clock signal received at the first input and the second clock signal received at the second input.

### BRIEF DESCRIPTION OF THE DRAWINGS

Embodiments of the present invention are described hereinafter, making reference to the appended drawings.

FIG. 1 shows a schematic circuitry of an inventive signal processing circuit according to a first embodiment of the present invention;

FIG. 2 shows the circuitry of an inventive signal processing circuit according to a second embodiment of the present invention;

FIG. 3 shows the circuitry of an inventive signal processing circuit according to a third embodiment of the present invention;

FIG. 4 shows a schematic representation of an inventive write phase frame and an idle frame; and

FIG. 5 shows a flow chart of an inventive FCK/CK training loop.

### DETAILED DESCRIPTION OF THE EMBODIMENTS

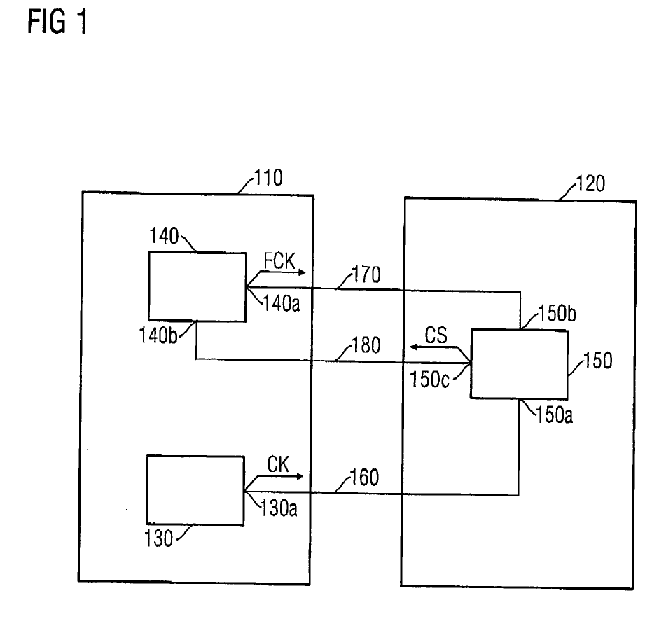

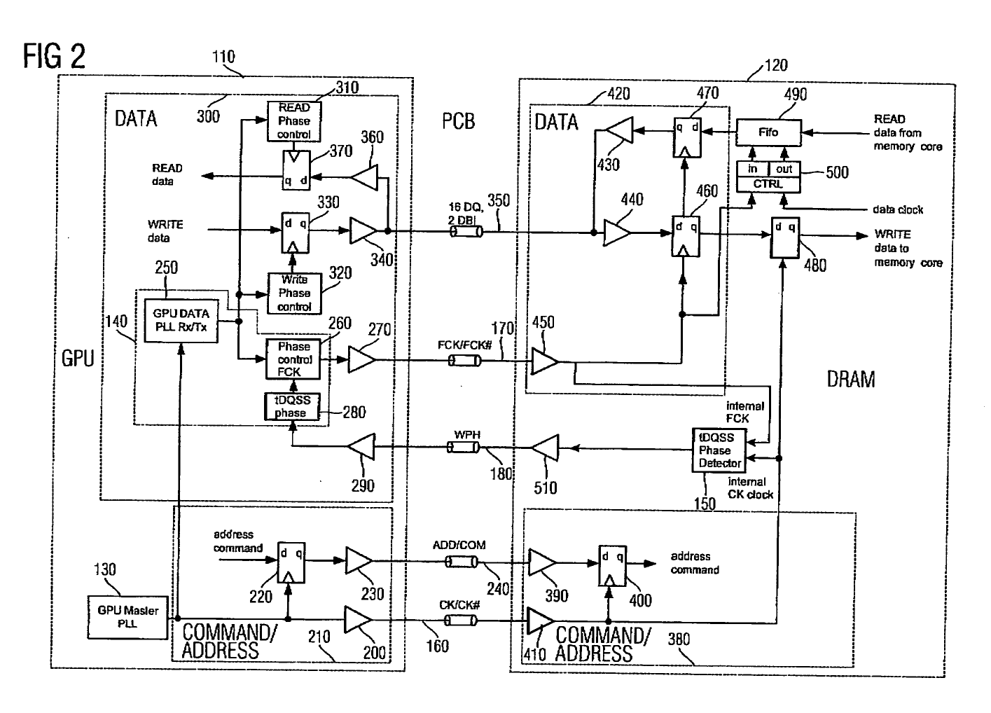

FIGS. 1 to 5 show the circuitries, a flowchart and examples of data frames of embodiments of a signal processing circuit according to the invention. Before a second and third embodiment of the present invention is described with respect to FIGS. 2 to 4, a first embodiment of an inventive signal processing circuit is explained with respect to the schematic representation of the circuitry of an inventive signal processing circuit shown in FIG. 1.

FIG. 1 shows an inventive signal processing circuit 100, which comprises a first circuit 110 and a second circuit 120. The first circuit 110 comprises a first clock signal generator 130 and a second clock signal generator 140. The first clock signal generator 130 is connected to a phase detector 150 comprised in the second circuit 120. To be more precise, the first clock signal generator 130 provides, at an output 130a, a first clock signal CK to a first clock signal line 160, connecting the output 130a of the first clock signal generator and a first input 150a of the phase detector 150. The second clock signal generator 140 provides, at an output 140a, a second clock signal FCK to a second clock signal line 170, which is connected to a second input 150b of the phase detector 150 of the second circuit 120. An output 150c of a phase detector 150 provides a comparison signal CS to a further signal line 180, which is connected to an input 140b of the second clock signal generator.

In the embodiments of an inventive signal processing circuit 100 shown in FIG. 1, the first clock signal CK and the second clock signal FCK (CK=Clock; FCK=Forward Clock) are generated by the first clock signal generator 130 and the second clock signal generator 140, respectively. Both clock signals CK and FCK have preferably the same frequency and possess both a defined phase, wherein the second clock signal FCK is based on the known RDQS signal. The second clock signal generator 140 is capable of adjusting the phase of the second clock signal FCK based on the comparison signal CS, which is provided to the second clock signal generator at the input 140b. The phase of the second clock signal FCK can, for instance, be adjusted by employing controllable, adjustable or trimmable delay circuits.

Both clock signals CK and FCK are provided by the first and the second clock signal line 170 and 180 to the phase detector 150, which compares the phases of the two clock signals CK and FCK. Depending on a relation between the phases of the first clock signal CK and the second clock signal FCK, the phase detector 150 provides the comparison signal CS at the output 150c indicating the relation between the phases of the firsts clock signal CK and the second clock signal FCK.

The comparison signal CS can, for instance, be an analog and/or a digital signal. Furthermore, the comparison signal CS can indicate a phase difference between the phase of the first clock signal CK and the phase of the second clock signal FCK, wherein, for instance, a negative value of the phase difference indicates that the second clock signal FCK is, with respect to the first clock signal CK, too early by an amount indicated by the comparison signal or an absolute value of the comparison signal. Accordingly, a positive value of the comparison signal CS can indicate that the first clock signal CK is late with respect to the first clock signal CK, e.g. by an amount indicated by the value of the comparison signal CS. Moreover, a comparison signal with an absolute value, which is lower than a predetermined value indicates the state in which the first clock signal CK and the second clock signal FCK are “in phase” and “synchronized” with respect to each other to an extent defined by the predetermined value. As the state does not require the second clock signal FCK or the phase of the second clock signal FCK to be modified or altered to reach a state in which both clock signals CK and FCK are synchronized or in phase with respect to the predetermined value, this state is also referred to as “hold”.

As an alternative to providing a comparison signal CS indicating the phase difference between the phases of the two clock signals CK and FCK, the comparison signal CS can just indicate a relation between the two phases of the two clock signals CK and FCK. For instance, the comparison signal CS can acquire the values indicating the states “early”, “late” and “hold”, depending on the value of the phase difference between the first and the second clock signal CK and FCK. If, for instance, the absolute value of the phase difference between the first clock signal and the second clock signal is within the predetermined value, the comparison signal CS can acquire a first state indicating to “hold”. Accordingly, if the second clock signal FCK precedes the first clock signal CK by more than the predetermined value, the comparison signal CS acquires a second state indicating “early”. Moreover, if the second clock signal FCK lags behind the first clock signal CK by more than the predetermined value, a third state indicating “late” is acquired by the comparison signal CS.

A further alternative for the phase detector 150 to provide the comparison signal CS at the output 150c is to utilize more than one predetermined value to indicate more than three states, as outlined above. Hence, a plurality of predetermined values can be used to indicate the phase difference between the first clock signal CK and the second clock signal FCK more accurately than by using only one predetermined value and three states. Accordingly, it is also possible to use different predetermined values for positive and negative phase differences between the first clock signal CK and the second clock signal FCK.

The second clock signal generator 140 changes or alters the second clock signal CFK depending on the comparison signal CS received at the input 140b of the second clock signal generator 140. If, for instance, the comparison signal CS indicates that the second clock signal FCK precedes the first clock signal CK (“early”), the second clock signal generator 140 can increase the phase of the second clock signal FCK to reduce the absolute value of the two clock signals CK and FCK. This can, for instance, be achieved by activating additional phase-shifting parts of the second clock signal generator 140 or by directly modifying the generated second clock signal FCK according to the comparison signal CS.

In the embodiment described above, the first circuit 110 can, for instance, be a graphics processing unit (GPU), a central processing unit (CPU) or another memory controller circuit. The second circuit 120 can, for instance, be a memory circuit comprising or being connected to a memory core to write data to and/or to read data from.

An advantage of the embodiments of the present invention is that the first clock signal and the second clock signal can more easily be aligned with respect to each other. As a consequence, the data transfer rate can more easily be increased without risking the negative influence on exchanging data between the first circuit and the second circuit. Furthermore, due to the alignment of the first clock signal and the second clock signal, the overall circuitry of the signal processing circuit can be simplified, as complex synchronization circuits can be omitted, which usually require an elaborate training scheme.

An advantage of an embodiment of the present invention is that an inventive signal processing circuit gives rise to the opportunity of employing a high data transfer rates between the first circuit and the second circuit (due to comparing the phases of the first clock signal and the second clock signal with respect to each other), while the synchronization of the control signals (in the CK domain) to the data signals (in the FCK domain) is considerably simplified. As a further advantage of an embodiment of the present invention, the circuitry of the signal processing circuit in general and the second circuit in detail can be simplified, as complex structures like a FIFO circuit (FIFO=First In First Out) do not have to be implemented. Furthermore, highly complex training procedures for the first circuit and the second circuit of the inventive signal processing circuit can also be omitted.

An embodiment of the present invention is based on the finding that the first clock signal CK and the second clock signal FCK can be more easily aligned with respect to each other by integrating an (auxiliary) phase detector 150 in the second circuit 120, which can, for instance, be a DRAM memory circuit (DRAM=Dynamic Random Access Memory).

In other words, a phase detector 150 is integrated into the second circuit, e.g. a DRAM memory circuit, which compares the first clock signal CK and the second clock signal FCK to obtain information concerning the phase difference between the two clock signals CK and FCK. The information as to whether the second clock signal FCK is too early, too late or “in time” (hold) with respect to the first clock signal CK is generated by the phase detector 150 and passed on via the further signal line 180 to the first circuit 110, which can, for instance, be a graphical processing unit GPU. The first circuit 110 can then use the information obtained via the comparison signal CS to alter the phase of the second clock signal FCK, which can, for instance, be a data clock signal, by employing a controllable delay circuit until the first clock signal CK and the second clock signal FCK are aligned to each other. This alignment can, for instance, be carried out with an accuracy of ⅛^{th} of a cycle period of the first clock signal or with any other accuracy, that can render a FIFO (FIFO=First In First Out) unnecessary due to the simplified synchronization, as explained above. As a consequence, employing complex circuits, like a FIFO to synchronize the second clock signal FCK with respect to the first clock signal CK can be left out.

In other words, at the interface between the part of the circuitry controlled by the second clock signal (FCK-domain) to the part of the circuitry of the second circuit 120 controlled by the first clock signal CK (CK-domain), an implementation of a FIFO can be omitted. As a consequence, the command-domain or CK-domain controls the data-domain or the FCK-domain, as if the data-domain was part of the command-domain. Accordingly, the inventive signal processing circuit enables a great simplification of a signal processing circuit comprising more than one clock signal, as due to the better alignment of the second clock signal FCK with respect to the first clock signal CK, as a complex FIFO-solution with its disadvantages concerning the area for the FIFO, its control, its influence on write times and read times can be omitted.

To be more precise, the time shifts with respect to the write times and the read times between the second clock signal FCK (data clock signal) with respect to the first clock signal CK (address/command clock signal) can increase the clock signal phase difference in some cases up to a whole clock cycle of the first clock signal CK. Hence, the synchronization of the data domain (FCK) and the command domain (CK) becomes more difficult. While the (net) data transfer rate remains the same, the latency (time between events, e.g. a write process and a following read process) will be increased. In other words, although the (net) data transfer rate is the same, the total number of data transferred can be increased with respect to time by employing an embodiment of the present invention leading to an increased effective data transfer rate.

Furthermore, the long and complex training procedures required to synchronize the FIFO circuits can also be omitted. Apart from the advantages of not having to incorporate a FIFO and of not having to carry out a long and complex training procedure, further advantages of the embodiments of the present invention are that restrictions with respect to the routing of the second clock signal line 170 with respect to the first clock signal line 160 can also be omitted. To be more precise, the inventive signal processing circuit does not pose restrictions on the layout of a printed circuit board to use equally long clock signal lines 160, 170. A further advantage of an inventive signal processing circuit is the fact that inside the first circuit 110, e.g. the GPU, the second clock signal generator 140 (FCK-clock) and the first clock signal generator 130 (CK-clock) do not have to be fully matched.

Hence, compared to circuits according to the standards or specifications DDR, DDR2, DDR3, GDDR3 and GDDR4, which specify a time difference tDQSS of the address/command clock signal and the data clock signal to be equal to or less than ¼^{th} of a clock signal period tCK (tDQSS=+/−0.25·tCK), an inventive signal processing circuit does not depend on the substantial effort for integrating or implementing an optimized layout with respect to the internal design of the first circuit 110 and the second circuit 120 and the design of the printed circuit board to match the signal paths between the first circuit 110 and the second circuit 120, especially the first clock signal line 160 and the second clock signal line 170.

By further increasing the data transfer rate between the first circuit 110 and the second circuit 120, the alignment between the first clock signal CK and the second clock signal FCK could be done but is very difficult and costly. This problem will for instance be important with respect to the new memory standard GDDR5. With respect to the frequency of the first clock signal CK, the time difference or rather the phase difference between the first clock signal CK and the second clock signal FCK, which is usually referred to as the tDQSS time, increases up to a value of +/−0.5·tCK, wherein tCK is again the period of the first clock signal CK. This essentially means that the first clock signal CK and the second clock signal FCK are not aligned with respect to each other, as the phase difference between the two clock signals can vary up to half a cycle in both directions.

The inventive signal processing circuit offers the advantage that a compensating FIFO at the interface between the FCK-domain and the CK-domain is not required. Apart from the advantage of saving the space for the FIFO circuit, as a second advantage, the long and complicated training procedure required to align the two clock signals with respect to each other, which would be necessary to determine which CK-clock edge belongs to which FCK-clock edge can be omitted. As a consequence, an inventive signal processing circuit is capable of a very fast power-up and capable of changing the clock frequency without a significant disturbance.

Before describing the second embodiment of the present invention in more detail, it should be noted that objects with the same or similar functional properties are denoted with the same reference signs. Unless explicitly noted otherwise, the description with respect to objects with similar or equal functional properties can be exchanged with respect to each other.

FIG. 2 shows a second embodiment of an inventive signal processing circuit 100. The signal processing circuit 100 comprises a first circuit 110, which is in the embodiment shown a graphical processing unit (GPU). Furthermore, the signal processing circuit 100 also comprises a second circuit 120, which is here a DRAM memory circuit. The GPU 110 and the DRAM memory 120 are mounted on a printed circuit board (PCB), as shown in FIG. 2.

The inventive signal processing circuit 100 shown in FIG. 2 also comprises a first clock signal generator 130, which is the GPU master PLL circuit (PLL=Phase Lock-Loop) providing a first clock signal CK via a first output driver 200 comprised in a command/address-domain 220 of the GPU 110. The GPU master PLL 130 is connected via the output driver 200 to a first clock signal line 160, which is referred to in FIG. 2 as CK/CK#. Inside the command/address domain 220, the GPU master PLL 130 is also connected to a clock signal input of a latch 220, which is provided with address and/or command data at the input d of the latch 220. An output q of the latch 220 is provided via an output driver 230 to an address/command signal line 240, which is also referred to as ADD/COM in FIG. 2.

The GPU master PLL 130 is furthermore connected to a second clock signal generator 140, which comprises a GPU data PLL Rx/Tx circuit or GPU data PLL 250. The GPU data PLL 250 generates an intermediate clock signal, which is provided to a phase control circuit 260, also comprised in the second clock signal generator 140. The phase control circuit 260 is connected via an output driver 270 to a second clock signal line 170, which is also referred to in FIG. 2 as FCK/FCK#. The second clock signal generator 140 also comprises a tDQSS phase circuit or decoder 280, which is connected to the phase control circuit 260 and via an input driver 290 to a further signal line 180, which is also called a WPH line.

Apart from the second clock signal generator 140, the output driver 270 and the input driver 290, a data-domain 300 also comprises a read phase control circuit 310 and a write phase control circuit 320, which are connected to an output of the GPU data PLL 250. The write phase control circuit 320 is connected to a latch 330 receiving data to be written at an input d of the latch 330. An output q of the latch 330 is connected via an output driver 340 to a plurality of 16 data lines (DQ; DQ=Data Query) and 2 data bit inversion lines (DBI), which, together, are referred to as data lines 350. The data lines 350 are also connected inside the data-domain 300 of the GPU 110 via an input receiver 360 to an input d of a latch 370. A clock signal input of the latch 370 is connected to the read phase control circuit 310. An output q of the latch 370 provides read data to the rest of the GPU 110.

The DRAM memory 120 also comprises command/address-domain 380, which is connected to the address/command signal line 240 and the first clock signal line 160. To be more precise, the address/command signal line 240 is connected via an input driver 390 to an input d of a latch 400 comprised in the command/address-domain 380. At an output q of the latch 400, address and/or command signals are provided to the rest of the DRAM memory 120. The command/address domain 380 furthermore comprises an input receiver 410, which is connected to a clock signal input of the latch 400.

The data lines 350 are connected to a data-domain 420 comprised in the DRAM memory 120. To be more precise, the data lines 350 are connected to both an output driver 430 and an input receiver 440. The second clock signal line 170 is also connected to an input receiver 450. An output of the input receiver 450 is connected to a clock signal input of a latch 460 and a latch 470. The latch 460 is furthermore connected with an input d to the input receiver 440 and with an output q to an input d of a latch 480. The latch 480 is connected with a clock signal input to the input driver 410 and, hence, triggered by the first clock signal CK. An output q of the latch 480 provides write data to a memory core not shown in FIG. 2. The latch 470 provides data via an output q to the output driver 430 to the data lines 350. The data provided by the latch 470 are received by an input d from a FIFO circuit 490, which is connected to the memory core not shown in FIG. 2 to receive read data from the memory core. The DRAM memory 120 furthermore comprises a control circuit 500, which is connected to the output of input receiver 450 and to a data clock line from the memory core. The control circuit 500 is furthermore connected to the FIFO circuit 490 and adapted for controlling the FIFO circuit 490.

Moreover, the DRAM memory 120 comprises a phase detector or tDQSS phase detector 150, which is connected to the input receiver 450 receiving the second clock signal FCK via the second clock signal line 170 and to the input receiver 410 receiving the first clock signal CK generated in essence by the first signal generator 130 of the GPU 110. The phase detector 150 is connected with an output to an output driver 510 providing a comparison signal to the further signal line 180.

The inventive signal processing circuit 100 shown in FIG. 2 is a second embodiment of the present invention in the field of fast DRAM memory circuits for use in graphical systems with a data clock (second clock signal FCK). In the embodiment shown in FIG. 2, the tDQSS phase detector 150 is integrated into the DRAM memory 120. To be more precise, the phase detector is integrated after the clock-input-receivers 450, 410 for the second clock signal FCK and the first clock signal CK. The phase detector 150 compares the first clock signal CK and the second clock signal FCK with respect to their phases and generates a comparison signal provided to the GPU 110 via the output driver 510 indicating whether the second clock signal FCK is too early, too late or in time (hold) compared to the first clock signal CK. The information, or rather the comparison signal, is provided to the controller or the GPU 110, via the further signal line 180. The GPU 110 can then adjust the phase of the second clock signal FCK, which is also referred to as the data clock signal FCK by controlling the phase control circuits 260 comprised in the second clock signal generator 140 by providing the decoder 280 with the comparison signal received from the input receiver 290 until the second clock signal FCK is aligned with respect to the first clock signal CK. The alignment is dependent on the phase detectors and/or the relative skew of input paths up to the phase detector. If these paths are well controlled, the accuracy can be much better than +/−0.125 tCK, wherein tCK is the period of the first clock signal CK and equal to the inverse of the frequency of the first clock signal CK. As a result of the achievable accuracy, an implementation of a FIFO at the interface between the command/address-domain 380 of the DRAM memory 120 for the second clock signal FCK can be omitted. The command/address-domain 380, which is also referred to as the command-domain or CK-domain, can hence control the data-domain 420 of the DRAM memory 120, as if the data-domain 420 was a part of the command-domain 380.

As already laid out, due to employing the phase detector 150 and employing the second clock signal generator 140, which is capable of controlling the phase of the second clock signal FCK, an implementation of a FIFO circuit as well as a long and complex training procedure can be omitted. Furthermore, no restrictions apply with respect to the layout of the first clock signal line 160 (CK-clock) and the second clock signal line 170 (FCK-clock) to be equally long. No restrictions apply inside the GPU 110 to fully match the second clock signal generator 140, or rather the FCK clock 140, to the first clock signal generator 130, or rather the CK clock 130.

In other words, the inventive signal processing circuit 100 shown in FIG. 2 represents an embodiment of a circuit incorporating a method for aligning a data clock (second clock signal FCK) to a command/address clock (first clock signal CK).

The closed feedback loop shown in FIG. 2 comprising the second clock signal generator 140, the output driver 270, the second clock signal line 170, the input receiver 450, the phase detector 150, the output driver 510, the further signal line 180 and the input receiver 290, the CPU 110 is capable of controlling the second clock signal generator 140 to such an extent that the second clock signal FCK is aligned to the first clock signal CK provided by the first clock signal generator 130. The closed feedback loop described above can be analog or digitally implemented. Furthermore, once the alignment of the clock signals FCK and CK is achieved, the closed feedback loop can be switched off, if a drift of the misalignment characterized by the time tDQSS, which is equal to the phase difference between the first clock signal CK and the second clock signal FCK in the time domain, is smaller over a certain period of time than allowed by an underlying specification of the inventive signal processing circuit.

If, however, a drift of the misalignments should become notable, the closed feedback loop can be activated periodically. In the case of a DRAM memory, the necessary auto-refresh cycle can be employed. During the time necessary for the auto-refresh cycle, the data lines 350 and, hence, the whole bus are not used, so that an update of the timing can easily be employed.

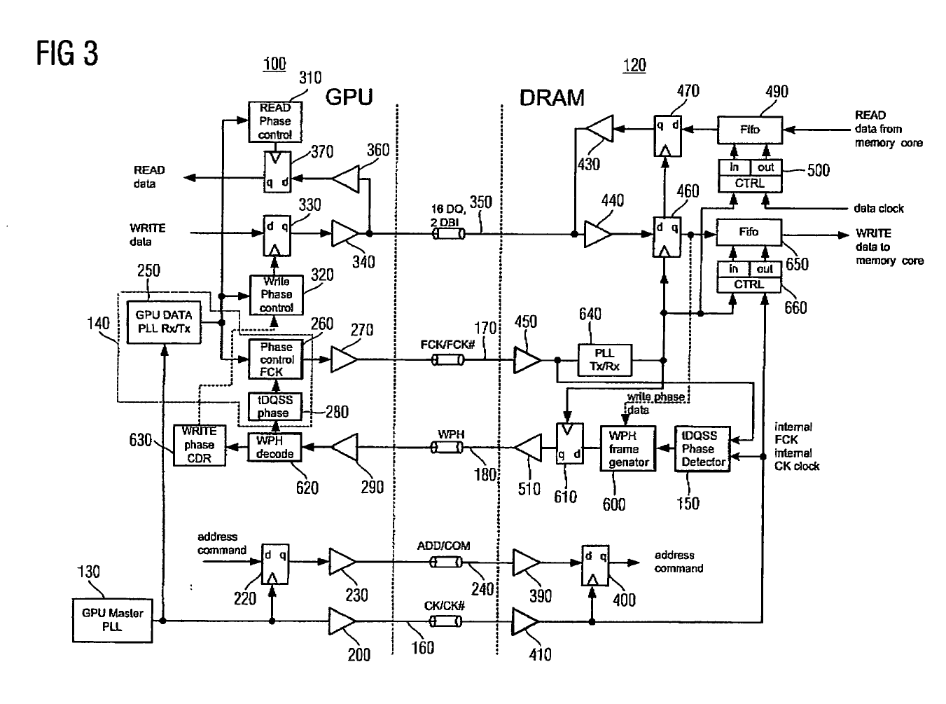

While FIG. 2 shows a schematic, more basic representation of an inventive signal processing circuit 100, FIG. 3 shows a more concrete implementation as a third embodiment of an inventive signal processing circuit 100 in the framework of a high speed memory controller circuit and memory circuit in the field of computer graphics. With respect to the embodiments shown in FIG. 3, a FCK/CK training loop will also be discussed in more detail later. FIG. 3 shows an embodiment of an inventive signal processing circuit, which differs only slightly from the embodiment shown in FIG. 2. To be more precise, the embodiment shown in FIG. 3 comprises an additional WPH frame generator 600 (WPH=write phase), which is connected to the output of the phase detector 150. Furthermore, the WPH frame generator 600 is connected to the output of the latch 460 receiving write phase data from the output q of the latch 460. An output of the WPH frame generator 600 is connected to an input d of a latch 610. An output q of the latch 610 is then connected to the output driver 510, which is then connected to the further signal line 180, which in the embodiment shown in FIG. 3, carries the so-called WPH signal or WPH frame data, among other data, to the GPU 110.

Furthermore, the GPU 110 comprises a WPH decoder 620, which is connected to the output of the input receiver 290 of the GPU 110. The WPH decoder 620 is connected to both the decoder 280 of the first clock signal generator 140 as well as to a write phase CDR circuit (CDR=Clock Data Recovery), which is connected to the write phase control 320 providing it with appropriate write phase control data. The WPH decoder 620 decodes the WPH data frames generated by the WPH frame generator 600, which comprise both information concerning the write phase (WPH) as well as the comparison signal CS, which is also referred to as tDQSS or tCK2FCK information generated by the phase detector 150.

Hence, the embodiment shown in FIG. 3 illustrates that the comparison signal CS does not have to be transmitted from the second circuit 120, i.e. the DRAM memory 120 in the embodiment shown in FIG. 3, to the first circuit 110, the GPU 110 in the embodiment shown in FIG. 3. As will be outlined below, it is possible to use an existing signal line to transmit the comparison signal CS from the second circuit 120 to the first circuit 110. In the embodiment shown in FIG. 3, this is done by encoding the comparison signal CS provided by the phase detector 150 in the framework of the WPH frame comprising phase information concerning the data bits transmitted over the data lines 350.

Furthermore, the embodiment shown in FIG. 3 differs from the embodiment shown in FIG. 2 with respect to an additional clock signal generator 640 in the DRAM memory 120, which is connected after the input receiver 450 connected to the second clock signal line 170. While, as in the embodiment shown in FIGS. 1 and 2 the phase detector 150 is in the embodiment shown in FIG. 3 also provided with the second clock signal after being processed by the input receiver 450, the data-domain of the DRAM memory is connected to an output of the further clock signal generator 640, which is labeled PLL Tx/Rx in FIG. 3. To be more precise, the two latches 460, 470 and the control circuit 500 is connected to the output of the further clock signal generator 640. A clock signal input of the latch 610 is also connected to the output of the further clock signal generator 640.

A further difference between the embodiments shown in FIGS. 2 and 3 is the replacement of the latch 480 of the embodiment shown in FIG. 2 with a more complex circuit comprising a FIFO circuit 650 providing a memory core not shown in FIG. 3 with data to be written to the memory core and the control circuit 660 for controlling the FIFO 650. The control circuit 660 is connected to the first clock signal generator via the input receiver 410 and to the further clock signal generator 640 of the DRAM memory 120.

In the implementation of the third embodiment shown in FIG. 3, the information concerning the phase relation between the second clock signal FCK and the first clock signal CK is provided to the GPU 110 via an existing WPH-pin. To be more precise, in the concrete implementation shown in FIG. 3, the comparison signal CS comprising the phase information early/late/hold of the phase detector 150 is encoded into the write phase frame by the WPH frame generator 600 and transferred to the GPU 110 via the further signal line 180, which is in the implementation shown in FIG. 3 also called the WPH line. The embodiment shown in FIG. 3 illustrates that it is not necessary to implement an additional line and an additional pin for transmitting the comparison signal CS. In the embodiment shown in FIG. 3, the WPH frame comprises 32 data bits, which also comprise the phase information of the data bits transferred over the data lines 350. However, it should be noted that the number of data bits as well as other number of bits transferred in the embodiments described are not limiting. They merely represent an example. It is, however, possible to use a different number of data lines 350 and/or a different number of data bits for the WPH or other data frames.

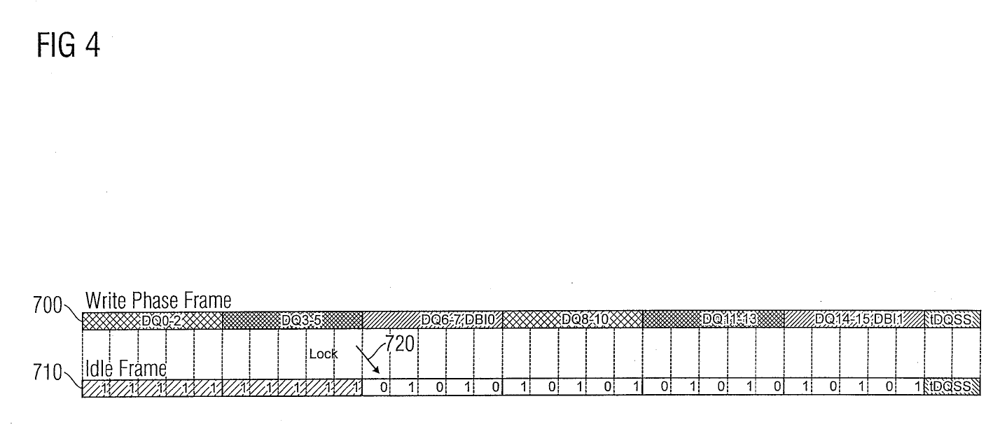

FIG. 4 shows an example of a new WPH frame used for transmitting phase information concerning the data bits transferred over the data lines 350 and comprising the comparison signal CS in the form of two bits for the tDQSS signal concerning the alignment of the phases of the first clock signal CK and the second clock signal FCK, which is also referred to as tCK2FCK. To be more precise, FIG. 4 shows a write phase frame or WPH frame 700 comprising 32 data bits of which the first 30 data bits comprise phase information concerning the 18 data line signals DQ0 to DQ15 and the two data bit inversion bits DBI0 and DBI1. The last two bits of the write phase frame 700 comprise the comparison signal, or rather the tDQSS signal.

In the embodiment shown in FIG. 3 together with the WPH frame 700 shown in FIG. 4, the three states of the comparison signal early, late and hold are indicated by the bit patterns 01 for early, 10 for late and 11 for hold. The data concerning the phases of the data bits transferred by the data lines 350 comprised in the WPH frame indicate the phase relations between WRITE data transferred by the data lines 350 from the GPU to the DRAM memory 120 and a clock signal provided by the further clock signal generator 640, which is sometimes also referred to as the internal clock signal of the DRAM memory 120. The WPH frame is generated by the WPH frame generator 600 and transferred to the GPU 110 and decoded by the WPH decoder 620. The WPH decoder 620 comprises in the embodiment shown in FIG. 3 a further read phase recovery circuit or a CDR circuit (CDR=Clock Data Recovery) for obtaining the data comprised in the WPH frame. To be more precise, the GPU 110 comprises the same phase control circuitry as for the write data circuit to decode the information provided by the (auxiliary) phase detector 150 of the DRAM memory 120 used to align the two clock signals CK and FCK. As an additional advantage, the additional phase control circuitry is also good for (noise) tracking of write data to the second clock signal FCK.

As already explained, the phase information concerning the phase relation between the first clock signal CK and the second clock signal FCK (tCK2FCK or tDQSS) can be sent back to the GPU 110 in the WPH frame by using two preamble bits, which are not really needed in terms of transferring write phase information. In a conventional WPH frame, the two preamble bits used for transferring the comparison signal CS (tCK2FCK or tDQSS) do not contain any information and are, hence, empty.

If, however, no write commands are carried out by the inventive signal processing circuit shown in FIG. 3 for more than four cycles, which are usually referred to as four burst or burst8, the WPH frame generator enters a so-called idle frame mode in which the WPH frame generator 600 generates an idle frame 710, which is also shown in FIG. 4. The idle frame 710 provides a simple means for locking the CDR circuit comprised in the WPH decoder 620 to the WPH frame transmitted over the further signal line 180. The CDR circuit of the WPH decoder 620 locks onto the first zero after ten times a bit 1 is transferred, which is also indicated in FIG. 4 by an arrow 720. Following the first ten bits, each having a value of 1, the idle frame 710 comprises a fixed toggle pattern comprising ten times an alternating bit sequence of 0 and 1. As in the case of a write phase frame 700, the last two bits of the idle frame 710 following by the fixed toggle pattern comprise the comparison signal in terms of the tDQSS information, as outlined above. The many transitions comprised in the idle frame 710 allow the READ phase circuit comprised in the WPH decoder 620 of the GPU 110 to follow the further clock signal generator 640, which is, as outlined above, a further phase lock loop circuit, locking onto the second clock signal FCK. In other words, the fixed toggle pattern of the idle frame 710 allows the GPU 110, or rather the read phase circuit comprised in the WPH decoder 620 to follow the PLL or the further clock signal generator 640 of the DRAM memory 120. At a clock frequency of the first clock signal of 1 GHz, which equals a data transfer rate of 4 Gbit/s, an update frequency for the inventive first clock signal CK to second clock signal FCK alignment of 31.25 MHz (=1 GHz/32 data bits) can easily be achieved.

The inventive signal processing circuit provides the opportunity of operating, for instance, a high speed memory circuit at a higher speed without creating a significant influence on the so-called write/read turnaround by being able to limit the phase difference between the first clock signal CK and the second clock signal FCK to far less than +/−0.5·tCK or +/−500 ps at a frequency of 1 GHz, which creates a great amount of problems concerning the timing and other effects in the write path of a memory circuit. Hence, an inventive signal processing circuit can render highly complex and lengthy write training solutions obsolete.

In the embodiment shown in FIG. 3, the control loop for the alignment of the first clock signal CK to the second clock signal FCK is very fast, as explained above. Hence, it is possible to use a filtered output of the phase detector 150 offering a resolution of 16:1 with respect to the phase difference between the first clock signal CK and the second clock signal FCK. As a consequence of both, only two bits are needed to align the second clock signal FCK with respect to the first clock signal CK, indicating the states up or early, down or late and hold. Hence, the embodiment described above and shown in FIG. 3 is easily capable of achieving a target phase difference between the first clock signal CK and the second clock signal FCK of +/−100 ps at a frequency of 1 GHz or better. after the alignment of the two clock signals, which is equal to a phase alignment of +/−0.1·tCK.

Before discussing a typical system power-on sequence of an inventive signal processing circuit shown in FIG. 3, it should be amplified that the comparison signal CS could be transferred from the second circuit 120 to the first circuit 110 in different ways. As shown in the first two embodiments depicted in FIGS. 1 and 2, the comparison signal CS can be transferred by a separate, further signal line 180. Alternatively, the comparison signal can be transmitted from the second circuit 120 to the first circuit 110 by using an existing line between the two circuits, as shown in the third embodiment depicted in FIG. 3. In this third embodiment, the tDQSS signal, or rather the comparison signal, CS is transferred over the so-called WPH line, which is used to synchronize write data. However, it should be noted that other lines connecting the two circuits 110, 120 could also be used.

Furthermore, an inventive signal processing circuit is not limited to using exactly the length or number of bits and/or number of bit lines, as described with respect to the three embodiments discussed above. It is possible to use a different number of bit lines and/or different number of bits.

Furthermore, with respect to the embodiments shown in FIGS. 2 and 3, it is important to note that the inner structure of the circuits 110, 120 is not limiting either. Although the second and third embodiments shown in FIGS. 2 and 3 show an inventive signal processing circuit comprising a GPU 110 as the first circuit 110 and a DRAM memory 120 as the second circuit 120, different circuits 110, 120 can be employed in the framework of an inventive signal processing circuit. As an example, the first circuit 110 can also be central processing units (CPU), while the second circuit 120 can be a memory circuit, a memory or another processor or processing unit, like a cryptographic co-processor.

Furthermore, it should be noted that the closed feedback loop comprising the second clock signal line 170, the further signal line 180, the second clock signal generator 140 and the phase detector 150 can be implemented as a digital and/or an analog feedback loop system. In addition, the comparison signal CS provided by the phase detector 150 can comprise more than three states, as described in the framework of the second and third embodiments of the present invention. To be more precise, the comparison signal CS can indicate an arbitrary number of states indicating the phase of the second clock signal FCK to be adjusted with respect to the first clock signal CK in both directions. In principle, the number of states indicated by the comparison signal CS is only limited by the number of bits available for the comparison signal CS if a digital transmission of the comparison signal CS is used or by the signal-to-noise-ratio of an analog comparison signal CS. Depending on the concrete implementation and the properties of the comparison signal CS, the second clock signal generator 140 can adjust the phase of the second clock signal FCK by increasing or decreasing the phase of the second clock signal FCK in discrete steps or in a continuous fashion. It is, for instance, possible to adjust the phase of the second clock signal FCK in a discrete number of steps. Due to the digital nature of most signal processing circuits comprised in computer systems, a second clock signal generator capable of shifting the phase of the second clock signal FCK in terms of steps of one cycle divided by 2ⁿ, wherein n is a positive integer, is especially favorable. However, any other discrete number of steps is also possible, e.g. a step of ⅛^{th}, 1/10^{th} or 1/16^{th} of a cycle.

Furthermore, in the embodiments shown in FIGS. 1 to 3, the first clock signal CK and the second clock signal FCK have the same frequency and, hence, the same period. Nevertheless, it is possible to generate the first clock signal CK with a different frequency from the second clock signal FCK. In this case, it is preferable to have the affixed ratio between the frequencies of the second clock signal FCK and the first clock signal CK, which are, depending on which frequency is larger, either given by R or 1/R, wherein R is a positive integer.

A typical system power-on sequence of an inventive signal processing circuit as described and shown in FIG. 3 comprises the following typical steps:

1. Turn on of the first clock signal generator 130 (GPU PLL). As the second clock signal generator 140 is coupled to the first clock signal generator 130 in the embodiment shown in FIG. 3, by turning on the first clock signal generator 130, also the second clock signal generator 140 is turned on.

2. Turn on the further clock signal generator 640 (DRAM PLL). After a certain period of time has elapsed, the further clock signal generator 640 has locked onto the second clock signal FCK provided by the second clock signal generator 140.

3. Turn on the CDR circuit comprised in the WPH decoder 620 (DQ-CDR or READ GPU) to enable decoding and obtaining the information comprised in the WPH frame received at the WPH-pin of the GPU 110. To be more precise, the CDR circuit comprised in the WPH decoder 620 is needed to decode the comparison signal CS or tDQSS signal provided by the phase detector 150 and encoded by the WPH frame generator 600 of the DRAM memory 120.

4. Align the second clock signal FCK to the first clock signal CK. As will be laid out later, this alignment process is carried out slowly compared to the alignment carried out by the CDR circuit comprised in the WPH decoder 620 to make sure that the CDR of the WPH decoder 620 is capable of keeping track of the WPH signal comprising the idle frame 710 or the write phase frame 700 shown in FIG. 4, as any change of the phase of the second clock signal FCK performed by the phase control circuit 260 of the second clock signal generator 140 also relates to the WPH signal transferred over the further signal line 180. In other words, a phase shift by the phase control circuit 260 is also applied to the CDR circuit and the CDR-phase shifter comprised in the WPH decoder 620. Hence, the CDR circuit of the WPH decoder 620 operates faster than the alignment of the second clock signal FCK with respect to the first clock signal CK.

5. Reset the FIFO circuits 490, 650 according to a target phase shift with respect to the first clock signal CK and the second clock signal FCK. If, for instance, the target phase shift of the inventive signal processing circuit is tDQSS=+/−⅛·tCK (+/−125 ps at a frequency of 1 GHz), the FIFO circuits 490, 650 are reset accordingly.

6. Turn off the phase detector 150. As outlined above, the alignment of the first clock signal CK and the second clock signal with respect to each other does not have to be carried out all the time.

7. Wait for a short, predetermined period of time for the CDR comprised in the WPH decoder 620 (DQ-CDR) to settle.

8. The DQ-CDR can now be used to write data to the DRAM memory 120 and to read data from the DRAM memory 120 to transfer the data to the GPU 110. The DQ-CDR is turned on during the step 3 above.

9. Depending on the alignment achieved or specified, the phase difference between the first clock signal CK and the second clock signal FCK is allowed to drift to a predetermined extent during the operation, before the feedback loop should be reactivated. In the case of a “perfect” alignment after the feedback loop is switched off, i.e. no or almost no phase difference between the first clock signal CK and the second clock signal FCK, the phase difference is in principle allowed to drift up to 0.5·tCK in either direction, until the feedback loop should be activated again. In case of a non-optimal alignment, the tolerable drift of the phase difference should be adjusted accordingly.

In essence, the power-on sequence comprises a CDR training loop, which leads to a state in which a read data eye is aligned with the incoming data and the position of the first bit (bit 0) in the burst is known. Nevertheless, the read/write latency is, at this point, not known. In a next step, the inventive FCK/CK training loop is executed, which leads to an alignment of the second clock signal FCK with respect to the first clock signal CK. The FCK/CK training loop will be described in more detail below. Afterwards, in the following steps, the latency times are determined and further initialization sequences are carried out.

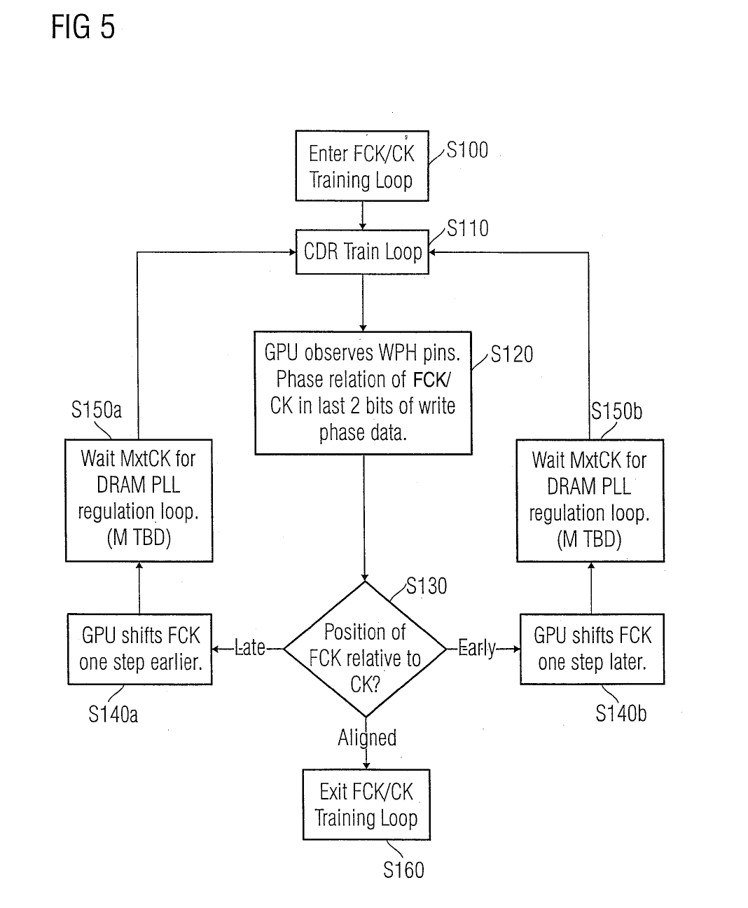

FIG. 5 shows a flow chart of the inventive FCK/CK training loop, which leads to an alignment of the second clock signal FCK to the first clock signal CK. After the start of the FCK/CK training loop in step S100, the CDR training loop of the CDR circuits comprised in the WPH decoder 620 is initiated in step S110. During step S110, the DRAM memory 120 provides data over the data lines 350 and the further signal line or rather WPH line 180 to the GPU 110. The CDR circuit comprised in the WPH decoder 620 then recovers a clock data from the WPH data transmitted over the further signal line 180 and checks if the recovered clock is in the center of the data eyes. If this is not the case, the GPU 110 shifts the incoming data or the recovered clock signal accordingly to compensate the misalignment of the recovered clock and the center of the data eyes. If necessary, this retrieving of data, checking if the recovered clock is in the center of the data eyes and the appropriate shifting of either the incoming data or the recovered clock will be repeated until the recovered clock is in the center of the data eyes. An internal pointer is then corrected, so that the recovered data transmitted from the DRAM memory 120 to the GPU 110 are in correct position. This is done by correcting an internal pointer inside the GPU 110 accordingly. If necessary, the whole procedure is repeated until both the recovered clock is in the center of the data eye and the recovered data are in the correct position. If both are ensured, the CDR loop (step S110) is exited.

In a next step, S120, the CPU 110 observes the data received at the WPH-pin. Furthermore, it extracts the comparison signal from the WPH frame, which is comprised in the last two bits of the write phase data indicating the relation between the second clock signal FCK to the first clock signal CK. In step S130, the position of the second clock signal FCK is determined in relation to the first clock signal CK. If the second clock signal FCK is late with respect to the first clock signal CK, the GPU 110 shifts the second clock signal FCK by adjusting the phase control circuit 260 accordingly one step earlier in step S140a. In a step S150a, the GPU 110 then waits for M clock cycles of the first clock signal CK and hence for a time M·tCK for the further clock signal generator 640 of the DRAM memory 120 and the DRAM PLL regulation loop to settle, wherein M is a positive integer. The system then once again enters the CDR training loop S110, as explained above.

If, however, the GPU 110 detects in step S130 that the position of the second clock signal FCK with respect to the first clock signal CK is early, the GPU 110 shifts the second clock signal FCK by adjusting the phase control circuit 260 accordingly one step later in step S140b. Afterwards, in step S150b, the GPU 110 waits for M clock cycles of the first clock signal CK to once again allow the DRAM PLL regulation loop of the further clock signal generator 640 of the DRAM memory 120 to settle before the CDR training loop is entered in step S110. In the steps S150a and S150b, the time waited by the GPU 110 is determined by the integer M, which can be a predetermined value, for instance, a value of 24, or can be adjusted according to the behavior of the inventive signal processing circuit.

If, finally, in step S130, the position of the second clock signal FCK with respect to the first clock signal CK is found to be aligned (hold), the FCK/CK training loop is exited in step S160.

Depending on certain implementation requirements of the inventive methods, the inventive methods can be implemented in hardware or in software. The implementation can be performed using a digital storage medium, in particular, a disc, CD or a DVD having an electronically readable control signal stored thereon, which co-operates with a programmable computer system such that an embodiment of the inventive methods is performed. Generally, an embodiment of the present invention is, therefore, a computer program product with a program code stored on a machine-readable carrier, the program code being operative for performing the inventive methods when the computer program product runs on the computer. In other words, embodiments of the inventive methods are, therefore, a computer program having a program code for performing at least one of the inventive methods when the computer program runs on a computer.

While the foregoing has been particularly shown and described with reference to particular embodiments thereof, it will be understood by those skilled in the art that various other changes in the form and details may be made without departing from the spirit and scope thereof. It is to be understood that various changes may be made in adapting to different embodiments without departing from the broader concept disclosed herein and comprehend by the claims that follows.

What is claimed is:

1. A signal processing circuit comprising:
a first circuit comprising a first clock signal generator with an output for a first clock signal and a second clock signal generator with an output for a second clock signal and an input for a comparison signal, wherein the second clock signal is generated by the second clock signal generator based on the comparison signal; and
a second circuit comprising a phase detector with a first input for the first clock signal, with a second input for the second clock signal and an output for the comparison signal indicating a relation between the phases of the first clock signal received at the first input and the second clock signal received at the second input.

2. The signal processing circuit according to claim 1, wherein the second clock signal is generated by the second clock signal generator based on the comparison signal such that an absolute value of a phase difference between the first clock signal and the second clock signal is reduced, when the absolute value of the phase difference does not fulfill a predetermined relationship.

3. The signal processing circuit according to claim 1, wherein the first circuit is integrated into a first chip and the second circuit is integrated into a second chip.

4. The signal processing circuit according to claim 1, further comprising:
a first clock signal line coupling the output of the first clock signal generator and the first input of the phase detector;
a second clock signal line coupling the output of the second clock signal generator and the second input of the phase detector; and
a further signal line coupling the output of the phase detector and the input of the second clock signal generator.

5. The signal processing circuit according to claim 4, wherein a printed circuit board comprises at least a part of the first clock signal line, a part of the second clock signal line and a part of the further signal line.

6. The signal processing circuit according to claim 1, wherein the comparison signal takes on a state of a plurality of discrete states indicating the relation between the phases of the first clock signal and the second clock signal.

7. The signal processing circuit according to claim 1, wherein the second clock signal generator comprises a clock signal generating circuit with an output for an intermediate clock signal comprising an intermediate phase and a phase shifter with an input for the intermediate clock signal and an output for the second clock signal, wherein the intermediate phase differs from the second phase depending on the comparison signal.

8. The signal processing circuit according to claim 1, wherein the first circuit comprises a memory controller or a processor and wherein the second circuit comprises a memory circuit.

9. The signal processing circuit according to claim 2, wherein the predetermined relationship of the phase difference between the first clock signal and the second clock signal is fulfilled, if an absolute value of the phase difference is smaller than or equal to a predetermined value.

10. The signal processing circuit according to claim 9, wherein the comparison signal comprises a first state indicating that the absolute value of the phase difference between the first clock signal and the second clock signal is within the predetermined value, a second state indicating that the second clock signal precedes the first clock signal by more than the predetermined value, and a third state indicating that the second clock signal lags the first clock signal by more than the predetermined value.

11. The signal processing circuit according to claim 10, wherein the second clock signal is generated with the phase earlier in case of the third state of the comparison signal, and wherein the second clock signal is generated with the phase later in case of the second state of the comparison signal, until the comparison signal comprises the first state.

12. A signal processing apparatus comprising:
a first circuit comprising a first clock signal generating means for generating a first clock signal and a second clock signal generating means for generating a second clock signal; and
a second circuit comprising a phase detecting means for receiving the first clock signal and the second clock signal, for detecting a relation between the phases of the first clock signal and the second clock signal and for providing the comparison signal indicating said relation;
wherein said second clock signal generating means generates the second clock signal based on the comparison signal such that an absolute value of a phase difference between the first clock signal and the second clock signal is reduced, if the absolute value of the phase difference does not fulfill a predetermined relationship.

13. The signal processing apparatus according to claim 12, wherein the first circuit is integrated into a first chip and the second chip is integrated into a second chip.

14. The signal processing apparatus according to claim 12, wherein the phase detecting means is dedicated for providing the comparison signal with a state of a plurality of discrete states indicating the relation between the first phase and the second phase.

15. The signal processing apparatus according to claim 12, wherein the second clock signal generating means comprises a further clock signal generating means for generating an intermediate clock signal comprising an intermediate clock signal and a phase shifting means for shifting the intermediate clock signal such that the second clock signal comprises a shifted phase.

16. The signal processing apparatus according to claim 12, wherein the predetermined relationship of the phase difference between the first clock signal and the second clock signal is fulfilled, if an absolute value of the phase difference is smaller than or equal to a predetermined value.

17. The signal processing apparatus according to claim 12, wherein the comparison signal comprises a first state indicating that the absolute value of the phase difference between the first clock signal and the second clock signal is within the predetermined value, a second state indicating that the second clock signal precedes the first clock signal by more than the predetermined value, and a third state indicating that the second clock signal lags the first clock signal by more than the predetermined value.

18. The signal processing apparatus according to claim 12, wherein the second clock signal is generated with the phase earlier in case of the third state of the comparison signal, and wherein the second clock signal is generated with the phase later in case of the second state of the comparison signal, until the comparison signal comprises the first state.

19. The signal processing apparatus according to claim 12, wherein the first circuit comprises a decoding means for decoding the comparison signal.

20. A signal processing circuit comprising:
a memory controller integrated into a first chip comprising a first clock signal generator with an output for a first clock signal, a second clock signal generating circuit with an output for an intermediate clock signal comprising an intermediate phase and a phase shifter with a first input for the intermediate clock signal, a second input for a comparison signal and an output for a second clock signal comprising a second phase; and
a memory circuit integrated into a second chip comprising a phase detector with a first input for the first clock signal, a second input for the second clock signal and an output for the comparison signal indicating a relation between the phases of the first clock signal and the second clock signal;
wherein the second clock signal is generated by the phase shifter based on the comparison signal such that an absolute value of a phase difference between the first clock signal and the second clock signal is reduced, when the absolute value of the phase difference does not fulfill a predetermined relationship; and
wherein the memory controller and the memory circuit are coupled by a first clock signal line for the first clock signal, a second clock signal line for the second clock and a further signal line for a further signal comprising the comparison signal.

21. The signal processing circuit according to claim 20, wherein the further signal further comprises a synchronizing signal dedicated to further synchronizing the memory controller and the memory circuit.

22. The signal processing circuit according to claim 20, wherein the memory controller further comprises a data input/output circuit with a bi-directional terminal connected to a data line for a data signal and a control output circuit with an output connected to a control line for a control signal, wherein the memory circuit comprises a memory input/output circuit with a bi-directional terminal connected to the data line and a control input circuit with an input connected to the control line for the control signal, wherein the first clock signal is a clock signal for the control signal, and wherein the second clock signal is a clock signal for a data signal.

23. The signal processing circuit according claim 20, wherein a printed circuit board comprises at least a part of the first clock signal line, a part of the second clock signal line and a part of the further signal line.

24. The signal processing circuit according to claim 20, wherein the comparison signal takes on a state of a plurality of discrete states indicating the relation between the phases of the first clock signal and the second clock signal.

25. The signal processing circuit according to claim 20, wherein the predetermined relationship of the phase difference between the first clock signal and the second clock signal is fulfilled, if an absolute value of the phase difference is smaller than or equal to a predetermined value.

26. The signal processing circuit according to claim 25, wherein the comparison signal comprises a first state indicating that the absolute value of the phase difference between the first clock signal and the second clock signal is within the predetermined value, a second state indicating that the second clock signal precedes the first clock signal by more than the predetermined value, and a third state indicating that the second clock signal lags the first clock signal by more than the predetermined value.

27. The signal processing circuit according to claim 26, wherein the second clock signal is generated with the phase earlier in case of the third state of the comparison signal, and wherein the second clock signal is generated with the phase later in case of the second state of the comparison signal, until the comparison signal comprises the first state.

28. A method for reducing a phase difference between a first clock signal and a second clock signal, the method comprising:
generating the first clock signal;
generating the second clock signal;
determining a relation between the phases of the first clock signal and the second clock signal; and
generating a comparison signal based on the relation between the first clock signal and the second clock signal;
wherein the second clock signal is generated based on the comparison signal such that an absolute value of a phase difference between the first clock signal and the second clock signal is reduced, when the absolute value of the phase difference does not fulfill a predetermined relationship.

29. The method according to claim 28, further comprising:
transmitting the first clock signal from a first circuit to a second circuit;
transmitting the second clock signal from the first circuit to the second circuit; and
transmitting the comparison signal from the second circuit to the first circuit.

30. The method according to claim 28, wherein the step of generating the second clock signal comprises a step of generating an intermediate clock signal comprising an intermediate phase and a step of shifting the intermediate phase of the intermediate clock signal to generate the second clock signal comprising the second phase.

31. A computer program for performing, when running on a computer, the method of claim 28.
